(19) United States
(12) Patent Application Publication
(10) Pub. No.: US 2017/0232898 A1
(43) Pub. Date: Aug. 17, 2017

(54) SURROUNDING IMAGE DISPLAY APPARATUS FOR A VEHICLE

(71) Applicants: TOYOTA JIDOSHA KABUSHIKI KAISHA, Toyota-shi (JP); FUJITSU TEN LIMITED, Kobe-shi (JP)

(72) Inventors: Kohei MAEJIMA, Nisshin-shi (JP); Yuichi INDOH, Toyota-shi (JP); Yukihisa YAMADA, Seto-shi (JP); Masahiro TAKAHASHI, Toyota-shi (JP); Miki MURASUMI, Kobe-shi (JP); Kouei KIYO, Kobe-shi (JP); Yuji YOSHIE, Kobe-shi (JP); Yukiko HATAKEYAMA, Kobe-shi (JP)

(73) Assignees: TOYOTA JIDOSHA KABUSHIKI KAISHA, Toyota-shi (JP); FUJITSU TEN LIMITED, Kobe-shi (JP)

(21) Appl. No.: 15/421,029

(22) Filed: Jan. 31, 2017

(30) Foreign Application Priority Data
Feb. 15, 2016 (JP) 2016-026123

(51) Int. Cl. B60R 1/00; H04N 5/247; H04N 7/18

(52) U.S. Cl. CPC B60R 1/002; H04N 7/181; H04N 5/247; B60R 2300/105; B60R 2300/202; B60R 2300/303; B60R 2300/70; B60R 2300/802

(57) ABSTRACT

A surrounding image display apparatus for a vehicle includes: left and right side cameras respectively configured to take left and right obliquely rear images of the vehicle including at least side regions of left and right rear wheels; a display device arranged in a vehicle cabin; and an electronic control device configured to control an image displayed on the display device. When a preset condition is satisfied, the electronic control device displays on the display device at least one of the left and right obliquely rear images, which are taken by the side cameras, respectively, such that a rear side of the vehicle corresponds to an upper side of the image.

### CROSS-REFERENCE TO RELATED APPLICATION

The disclosures of Japanese Patent Application No. JP 2016-26123 filed on Feb. 15, 2016 is incorporated herein by reference in its entirety.

### BACKGROUND

1. Technical Field

The present disclosure relates to a surrounding image display apparatus to be used in a vehicle, e.g., a motor vehicle.

2. Description of the Related Art

A vehicle, e.g., a motor vehicle, has a blind spot, which is a region that cannot be visually recognized by a driver directly or even with a reflective mirror. Accordingly, a surrounding image display apparatus configured to take an image of a blind spot with a camera and display the taken image on a display device mounted in a vehicle cabin has been developed and has already been put into practical use. With the surrounding image display apparatus, the driver can check a state of the blind spot taken by the camera by viewing the image displayed on the display device.

For example, in Japanese Patent Application Laid-open No. Hei 10-236228, there is disclosed a surrounding image display apparatus configured to take images of blind spots when a vehicle travels backward with a plurality of video cameras mounted to the vehicle and display the taken images on a display device for displaying blind spots. In an embodiment of Japanese Patent Application Laid-open No. Hei 10-236228, the surrounding image display apparatus includes a rear video camera configured to take an image of a blind spot directly behind the vehicle and left and right video cameras configured to take images of left and right blind spots obliquely behind the vehicle, respectively.

The surrounding image display apparatus disclosed in Japanese Patent Application Laid-open No. Hei 10-236228 includes a travel path detector configured to detect a travel direction of the vehicle and identify a blind spot in the travel direction. The surrounding image display apparatus is configured to display on the display device, among the images taken by the plurality of video cameras, an image of the blind spot in the travel direction identified by the travel path detector. Accordingly, not only when the vehicle travels straight backward but also when the vehicle travels backward while turning left or right, for example, an image of an obliquely rear blind spot of the vehicle including a side region of a rear wheel that is not even reflected in a side-view mirror can be displayed.

However, in Japanese Patent Application Laid-open No. Hei 10-236228, there is no disclosure of how the images taken by the left and right video cameras are displayed on the display device. When a vehicle that does not include the surrounding image display apparatus travels backward, a driver checks a state behind the vehicle through use of a rear-view mirror and a side-view mirror. The rear-view mirror and the side-view mirror reflect an image behind the vehicle such that a rear side of the vehicle corresponds to an upper side of each mirror. Accordingly, when the images taken by the left and right video cameras are displayed such that the rear side of the vehicle corresponds to an upper side of each image, the driver is confused when checking the state of the blind spot by viewing the image displayed on the display device.

In particular, when the left and right video cameras are configured to take side images of the vehicle (“side” direction corresponds to a direction perpendicular to a front-and-rear direction of the vehicle when viewed from above) and images of left and right obliquely rear blind spots of the vehicle are generated by electronically processing left and right side images, a lower side of the images of left and right blind spots corresponds to the rear side of the vehicle. In other words, a relation between upper and lower sides of the left and right obliquely rear images and front and rear sides of the vehicle is opposite to a relation between upper and lower sides of an image reflected in the rear-view mirror and the side-view mirror and the front and rear sides of the vehicle.

### SUMMARY

It is a primary object of exemplary aspects of the present disclosure to provide a surrounding image display apparatus capable of displaying left and right obliquely rear images of a vehicle including side regions of left and right rear wheels so as to prevent a driver from being confused when the driver checks a state of a blind spot by viewing an image displayed on a display device.

According to one embodiment of the present disclosure, there is provided a surrounding image display apparatus for a vehicle, including: a left image pickup device configured to take a left obliquely rear image of the vehicle including at least a side region of a left rear wheel; a right image pickup device configured to take a right obliquely rear image of the vehicle including at least a side region of a right rear wheel; a display device arranged in a vehicle cabin; and a control device configured to control an image displayed on the display device.

When a preset condition is satisfied, the control device displays on the display device at least one of the left obliquely rear image and the right obliquely rear image, which are taken by the left image pickup device and the right image pickup device, respectively, such that a rear side of the vehicle corresponds to an upper side of the at least one of the left obliquely rear image and the right obliquely rear image.

According to the above-mentioned configuration, the left and right obliquely rear images of the vehicle including at least the side regions of the left and right rear wheels are taken by the left and right image pickup devices, respectively. Further, when the preset condition is satisfied, at least one of the left and right obliquely rear images respectively taken by the left and right image pickup devices is displayed on the display device such that the rear side of the vehicle corresponds to the upper side of the image.

The left and right obliquely rear images are displayed such that the upper side thereof corresponds to the rear side of the vehicle similarly to images reflected in a rear-view mirror and a side-view mirror. Accordingly, a relation between upper and lower sides of the left and right obliquely rear images and front and rear sides of the vehicle is the same as a relation between upper and lower sides of the images reflected in the rear-view mirror and the side-view mirror and the front and rear sides of the vehicle. Therefore, even when a driver also uses the rear-view mirror or the side-view mirror to check a state of the rear side of the vehicle, the driver can check states of left and right obliquely rear sides of the vehicle including the side regions of the left and right rear wheels without being confused.

In one aspect of the present disclosure, a surrounding image display apparatus further includes a travel direction image pickup device configured to take an image of a travel direction of the vehicle, and when the preset condition is satisfied, the control device displays on the display device the image of the travel direction of the vehicle taken by the travel direction image pickup device, and the left obliquely rear image and the right obliquely rear image on left and right sides of the image of the travel direction of the vehicle, respectively.

According to the above-mentioned aspect, when the preset condition is satisfied, on the display device, the image of the travel direction of the vehicle is displayed, and the left and right obliquely rear images of the vehicle are displayed on the left and right sides of the image, respectively. Accordingly, by viewing the images displayed on the display device, the driver can indirectly view the travel direction of the vehicle and left and right obliquely rear directions of the vehicle. Therefore, even without viewing the images reflected in the rear-view mirror and the side-view mirror, the driver can check states of the travel direction of the vehicle and the left and right obliquely rear directions of the vehicle.

In another aspect of the present disclosure, the travel direction image pickup device is a rear image pickup device configured to take a rear image of the vehicle, and when the preset condition is satisfied, the control device displays on the display device the rear image of the vehicle taken by the rear image pickup device, and displays the left obliquely rear image and the right obliquely rear image on left and right sides of the rear image of the vehicle, respectively.

According to the above-mentioned aspect, when the preset condition is satisfied, on the display device, the rear image of the vehicle is displayed, and the left and right obliquely rear images are displayed on the left and right sides of the rear image, respectively. Accordingly, by viewing the images displayed on the display device, the driver can indirectly view a rear direction of the vehicle and the left and right obliquely rear directions of the vehicle. Therefore, for example, by viewing the images displayed on the display device when the vehicle travels backward, the driver can check states of the rear direction of the vehicle and the left and right obliquely rear directions of the vehicle even without viewing the images reflected in the rear-view mirror and the side-view mirror.

Further, in another aspect of the present disclosure, the preset condition includes a condition that the travel direction of the vehicle is a backward direction.

According to the above-mentioned aspect, unless the travel direction of the vehicle is the backward direction, the rear image of the vehicle and the left and right obliquely rear images of the vehicle are not displayed on the display device. Thus, unnecessary display of the rear image of the vehicle and the left and right obliquely rear images of the vehicle can be prevented.

Further, in another aspect of the present disclosure, the control device is configured to display a guide line for guiding backward travel of the vehicle in the rear image of the vehicle, and to display left and right end portions of the guide line and regions surrounding the left and right end portions that are displayed in the rear image of the vehicle also in the left obliquely rear image and the right obliquely rear image, respectively.

According to the above-mentioned aspect, the guide line for guiding the backward travel of the vehicle is displayed in the rear image of the vehicle, and the left and right end portions of the guide line and the regions surrounding the left and right end portions that are displayed in the rear image of the vehicle are also displayed in the left and right obliquely rear images, respectively. Accordingly, the left and right end portions of the guide line and the regions surrounding the left and right end portions are displayed in both of the rear image and the left and right obliquely rear images of the vehicle. Therefore, as compared with a case where the left and right end portions of the guide line and the regions surrounding the left and right end portions are displayed in only one of the rear image and the left and right obliquely rear images of the vehicle, the driver can more easily and appropriately recognize a relation between a target object within the rear image of the vehicle and a target object within the left and right obliquely rear images.

Further, in another aspect of the present disclosure, the travel direction image pickup device is a front image pickup device configured to take a front image of the vehicle, and when the preset condition is satisfied, the control device displays on the display device the front image of the vehicle taken by the front image pickup device, and the left obliquely rear image and the right obliquely rear image on left and right sides of the front image of the vehicle, respectively.

According to the above-mentioned aspect, on the display device, the front image of the vehicle is displayed, and the left and right obliquely rear images are displayed on the left and right sides of the front image, respectively. Accordingly, the driver can drive the vehicle forward while checking states of a front direction of the vehicle and the left and right obliquely rear directions of the vehicle by viewing the images displayed on the display device. Therefore, for example, by viewing the images displayed on the display device when the vehicle travels forward, the driver can check the states of the left and right obliquely rear directions of the vehicle even without viewing the images reflected in the rear-view mirror and the side-view mirror, to thereby prevent, for example, the rear wheel from catching on an obstacle when the vehicle travels forward.

Further, in another aspect of the present disclosure, a surrounding image display apparatus further includes a switch to be operated by an occupant of the vehicle to set an image display mode, and the preset condition includes a condition that the image display mode set through the switch is a mode of displaying the front image of the vehicle.

According to the above-mentioned aspect, unless the image display mode is set to the mode of displaying the front image of the vehicle through the switch, the front image of the vehicle is not displayed. Thus, unnecessary display of the front image of the vehicle and the left and right obliquely rear images of the vehicle can be prevented. Further, the occupant of the vehicle can set the image display mode to the mode of displaying the front image of the vehicle by operating the switch as necessary.

Further, in another aspect of the present disclosure, the control device is configured to display, between the image of the travel direction of the vehicle and each of the left obliquely rear image and the right obliquely rear image, a separator for separating the images from each other.

According to the above-mentioned aspect, the separator is displayed between the image of the travel direction of the vehicle and each of the left and right obliquely rear images, and those images are separated from each other by the separator. Accordingly, as compared with a case where the separator is not displayed, a boundary between the image of the travel direction of the vehicle and each of the left and right obliquely rear images can be recognized more easily. Thus, a target object within each image can be recognized more easily.

### BRIEF DESCRIPTION OF THE DRAWINGS

FIG. 1 is a schematic configuration diagram for illustrating a surrounding image display apparatus for a vehicle according to a first embodiment of the present disclosure.

FIG. 2 is a block diagram of the surrounding image display apparatus illustrated in FIG. 1.

FIG. 3 is an image switch control diagram for illustrating various image display modes according to the first embodiment.

FIG. 4 is a diagram for illustrating an example of an image at the time when the image display mode is a complex rear display mode and in which guide lines are also displayed in left-side and right-side images according to the first embodiment.

FIG. 5 is a diagram for illustrating an example of an image at the time when the image display mode is a complex rear display mode and in which the guide lines, rear-wheel position assist lines, and side assist lines are displayed in the left-side and right-side images according to the first embodiment.

FIG. 6 is a diagram for illustrating an image at the time when the image display mode is a complex rear display mode and in which the guide lines, the rear-wheel position assist lines, and the side assist lines are not displayed in the left-side and right-side images according to the first embodiment.

FIG. 7 is a diagram for illustrating an example of an image at the time when the image display mode is a complex front display mode and in which the guide lines are not displayed in the left-side and right-side images according to the first embodiment.

FIG. 8 is a diagram for illustrating an example of an image at the time when the image display mode is a complex front display mode and in which the guide lines, the rear-wheel position assist lines, and the side assist lines are also displayed in the left-side and right-side images according to the first embodiment.

FIG. 9 is a schematic configuration diagram for illustrating a surrounding image display apparatus for a vehicle according to a second embodiment of the present disclosure.

FIG. 10 is an image switch control diagram for illustrating various image display modes according to the second embodiment.

FIG. 11 is a diagram for illustrating an example of an image at the time when the image display mode is a rear-and-overhead-view display mode according to the second embodiment.

FIG. 12 is a diagram for illustrating an example of an image at the time when the image display mode is a front-and-side display mode according to the second embodiment.

### DETAILED DESCRIPTION

Now, with reference to the accompanying drawings, some preferred embodiments of the present disclosure are described in detail.

### First Embodiment

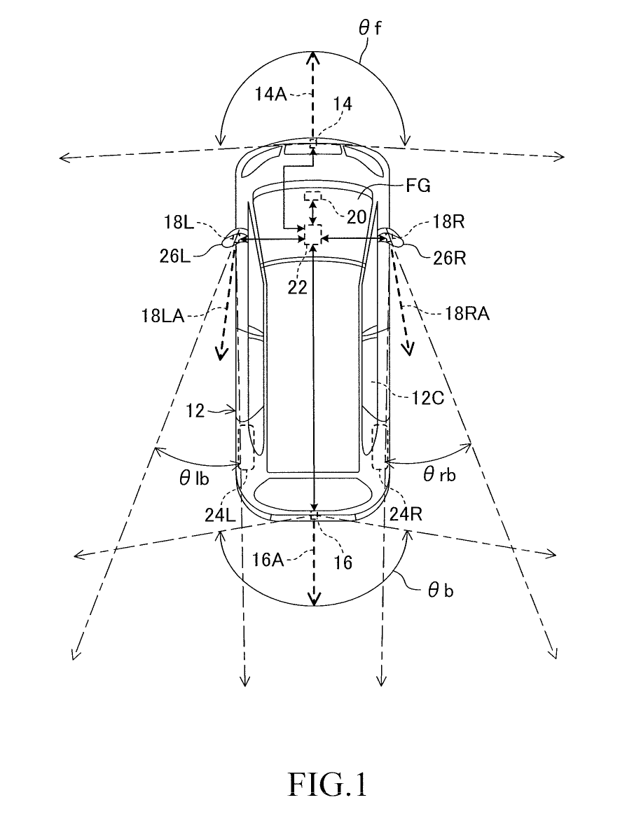

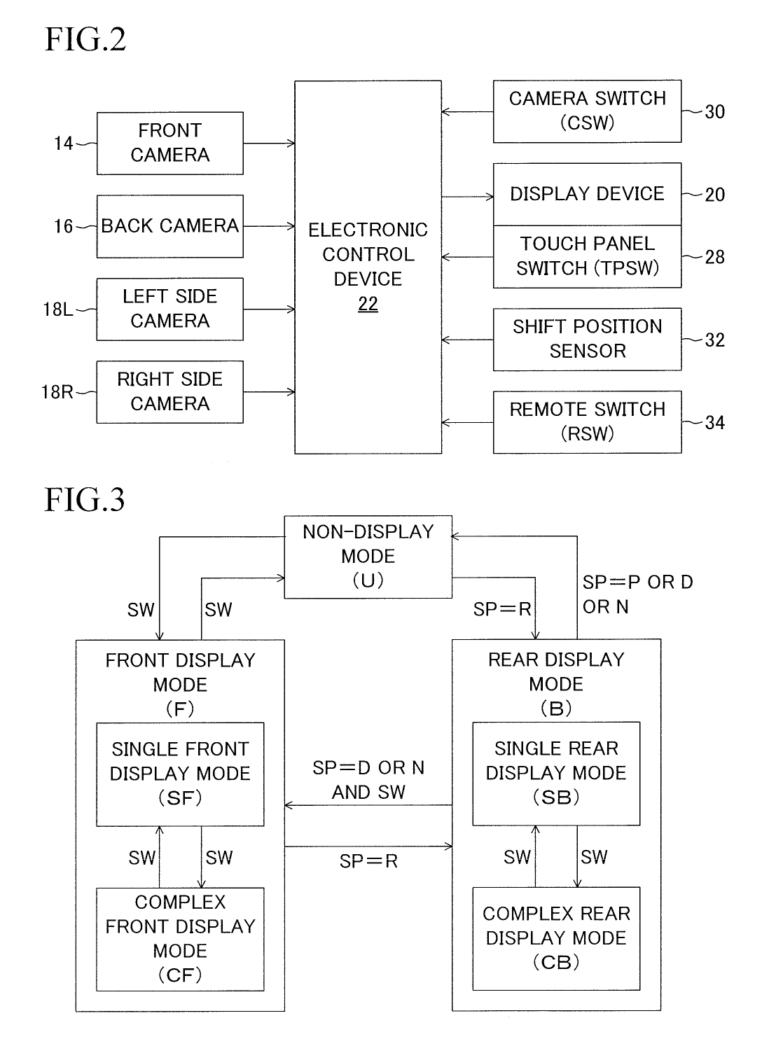

FIG. 1 is a schematic configuration diagram for illustrating a surrounding image display apparatus 10 for a vehicle according to a first embodiment of the present disclosure. FIG. 2 is a block diagram of the surrounding image display apparatus 10 illustrated in FIG. 1.

In FIG. 1, the surrounding image display apparatus 10 is mounted to a vehicle 12, and includes a front camera 14, a back camera 16, left and right side cameras 18L and 18R, a display device 20, and an electronic control device 22. Although not shown in FIG. 1, each of the cameras 14, 16, 18L, and 18R is a video camera including a lens and an image pickup element, and is configured to periodically take an image at predetermined periods (e.g., every 1/30 second).

In particular, the front camera 14 and the back camera 16 each function as a travel direction image pickup device configured to take an image of a travel direction of the vehicle 12. In other words, the front camera 14 is configured to take a front image of the vehicle 12 when the vehicle 12 travels forward and when the vehicle 12 is parked or stopped, and the back camera 16 is configured to take a rear image of the vehicle 12 when the vehicle 12 travels backward. The left and right side cameras 18L and 18R function as left and right image pickup devices, and are configured to take left and right obliquely rear images of the vehicle 12 including at least side regions of left and right rear wheels 24L and 24R, respectively.

The front camera 14 is mounted at a front end (preferably at a center in a vehicle width direction) of the vehicle 12, and an optical axis 14A of the front camera 14 is set in a front direction (forward direction) of the vehicle 12. The back camera 16 is mounted at a rear end (preferably at a center in the vehicle width direction) of the vehicle 12, and an optical axis 16A of the back camera 16 is set in a rear direction (backward direction) of the vehicle 12. The left and right side cameras 18L and 18R are mounted to left and right side-view mirrors 26L and 26R of the vehicle 12, respectively, and optical axes 18LA and 18RA of the side cameras 18L and 18R are set in left and right obliquely rear directions (side and rear directions) of the vehicle 12, respectively.

Lenses of the front camera 14 and the back camera 16 are each a wide-angle lens, e.g., a fisheye lens. The front camera 14 has an angle of view θf of about 180 degrees, and the back camera 16 has an angle of view θb, which is smaller than the angle of view θf. In contrast, lenses of the side cameras 18L and 18R are each a lens, e.g., a standard lens, and have angles of view θlb and θrb, respectively, which are smaller than the angles of view θf and θb of the cameras 14 and 16. The front camera 14 may be mounted at an upper end portion of an inner side of a windshield FG of the vehicle 12.

The display device 20 is mounted inside of a vehicle cabin 12C of the vehicle 12 so that at least a driver may visually recognize a screen of the display device 20, and is configured to display an image of the periphery of the vehicle 12. As schematically illustrated in FIG. 2, a touch panel switch (TPSW) 28 that can be operated by an occupant of the vehicle 12 is built into the display device 20. The display device 20 may be a liquid crystal display device different from a display device of a navigation device (not shown), or may be the display device of the navigation device. The display device 20 may also be a display device mounted to a rear-view mirror or a display device built into the windshield.

To the electronic control device 22, a signal indicating an image display mode set through the touch panel switch 28 is input from the touch panel switch 28, and a signal indicating on/off of a camera switch (CSW) 30 is input from the camera switch 30. Although not shown in FIG. 1, a shift position sensor 32 is mounted to a transmission of the vehicle 12, and to the electronic control device 22, a signal indicating a shift position (SP) of the transmission is input from the shift position sensor 32 via a transmission control device.

Further, to the electronic control device 22, a signal indicating an image display mode set through a remote switch (RSW) 34 of, for example, a touch pad type is input from the remote switch 34. The remote switch 34 may be mounted to a steering wheel (not shown) or an instrument panel (not shown). The surrounding image display apparatus 10 is configured to operate when an ignition switch (not shown) is on, and the cameras 14, 16, 18L, and 18R are configured to operate when the camera switch 30 is on.

As illustrated in FIG. 3, the image display mode includes a non-display mode (U), a rear display mode (B), and a front display mode (F). The rear display mode includes a single rear display mode (SB) and a complex rear display mode (CB), and the front display mode includes a single front display mode (SF) and a complex front display mode (CF). As described later in detail, the image display mode may be set to be changed through any one of the touch panel switch 28 and the remote switch 34.

Although not shown, the touch panel switch 28 and the remote switch 34 each include a main switch, a sub switch, and an assist line switch. The main switch is configured to switch the image display mode among the non-display mode (U), the rear display mode (B), and the front display mode (F). The sub switch is configured to switch the image display mode between a single display mode and a complex display mode, that is, between the single rear display mode (SB) and the complex rear display mode (CB) and between the single front display mode (SF) and the complex front display mode (CF). The assist line switch is configured to switch a mode between a mode of displaying an assist line (described in detail later) in a displayed image and a mode of not displaying the assist line in the displayed image.

The main switch and the sub switch may be integrated into one mode switch. In this case, each time the mode switch is pressed, the image display mode may be switched to, for example, the non-display mode (U), the single rear display mode (SB), the complex rear display mode (CB), the single front display mode (SF), and the complex front display mode (CF) in the stated order.

The electronic control device 22 functions as a control device configured to control, based on image information input thereto, a set image display mode, and a shift position, an image displayed on the display device 20 in accordance with a control program corresponding to an image switch control diagram of FIG. 3. The electronic control device 22 may be, for example, a microcomputer including a CPU, a ROM, a RAM, and an input/output port, which are connected to one another by a bidirectional common bus. The control program is stored in the ROM, and an image to be displayed is controlled by the CPU in accordance with the control program.

Next, referring to the image switch control diagram of FIG. 3, an image to be displayed on the display device 20 and image switch control according to the first embodiment are described in detail. In the following description, the camera switch 30 is on. When the camera switch 30 is off, the image display mode is set to the non-display mode (U).

<Non-Display Mode (U)>

When the main switch is in a position of the non-display mode (U), the image display mode is set to the non-display mode (U). In the non-display mode (U), an image taken by the front camera 14 or other cameras is not displayed. When the display device 20 is the display device of the navigation device, an image of the navigation device is displayed. When the display device 20 is the display device other than the display device of the navigation device, no image is displayed.

When the shift position (SP) is switched to “R” (reverse position) under a state in which the image display mode is set to the non-display mode (U), the image display mode is switched to the rear display mode (B). Even when the shift position (SP) is switched to a position other than “R” (reverse position), e.g., “P” (parking position), “D” (drive position), or “N” (neutral position) under the state in which the image display mode is set to the non-display mode (U), the image display mode is kept at the non-display mode (U).

Further, when the main switch of the touch panel switch 28 or the remote switch 34 is switched to the front display mode (F) under the state in which the image display mode is set to the non-display mode (U), the image display mode is switched to the front display mode (F).

<Rear Display Mode (B)>

In the rear display mode (B), at least a rear image of the vehicle 12 taken by the back camera 16 is displayed. In particular, when the image display mode is the single rear display mode (SB), only the rear image of the vehicle 12 is displayed. In contrast, when the image display mode is the complex rear display mode (CB), the rear image of the vehicle 12 is displayed, and left and right obliquely rear images of the vehicle 12 taken by the side cameras 18L and 18R are displayed on left and right sides of the rear image, respectively.

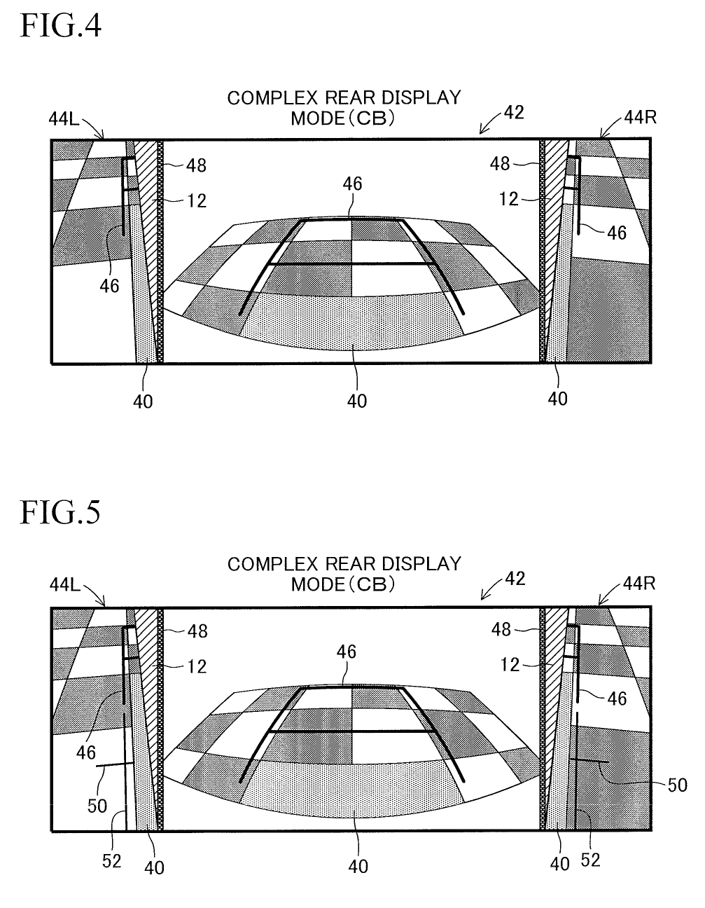

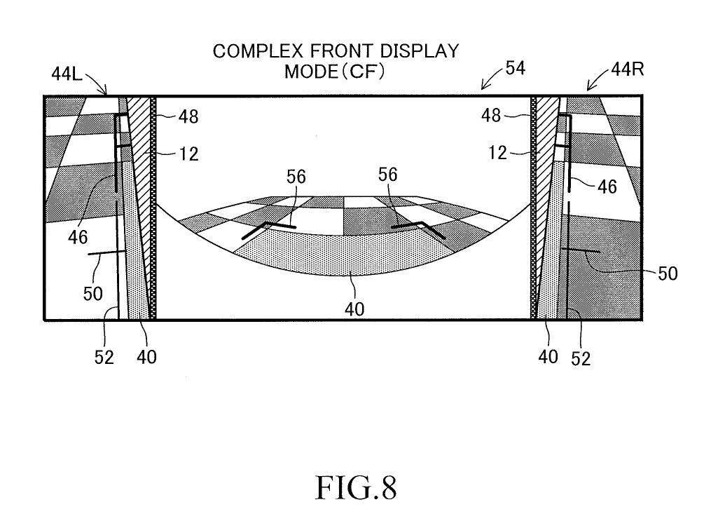

FIG. 4 to FIG. 6 are illustrations of examples of images at the time when the image display mode is the complex rear display mode (CB). The images illustrated in FIG. 4 to FIG. 6 and images illustrated in FIG. 7 and FIG. 8 described later are images at the time when the vehicle 12 is located in a light gray region 40 in an image pickup location having a floor in which rectangular regions are alternately colored in gray and white.

In FIG. 4 to FIG. 6, a center image 42 is the rear image of the vehicle 12 taken by the back camera 16, and images 44L and 44R on left and right sides of the image 42 are obliquely rear images of the vehicle 12 taken by the side cameras 18L and 18R, respectively. The obliquely rear images 44L and 44R are displayed such that a rear side of the vehicle 12 corresponds to an upper side of each image, similarly to the image 42. The black line displayed in the center image 42 that is the rear image is a guide line 46 for guiding backward travel of the vehicle 12. Between the center image 42 and each of the left and right obliquely rear images 44L and 44R, a separator 48 for separating those images from each other is displayed.

In particular, in the images illustrated in FIG. 4 and FIG. 5, the guide lines 46 are also displayed in the left and right obliquely rear images 44L and 44R. In the image illustrated in FIG. 5, in the left and right obliquely rear images 44L and 44R, the guide lines 46 are displayed, and rear-wheel position assist lines 50 respectively indicating positions where the left and right rear wheels 24L and 24R (see FIG. 1) are in contact with the ground are displayed. Further, in the image illustrated in FIG. 5, a side assist line 52 for assisting the driver in grasping the distance from the vehicle 12 to an obstacle or the like on one side of the vehicle 12 is also displayed. Display of one of the rear-wheel position assist line 50 and the side assist line 52 may be omitted.

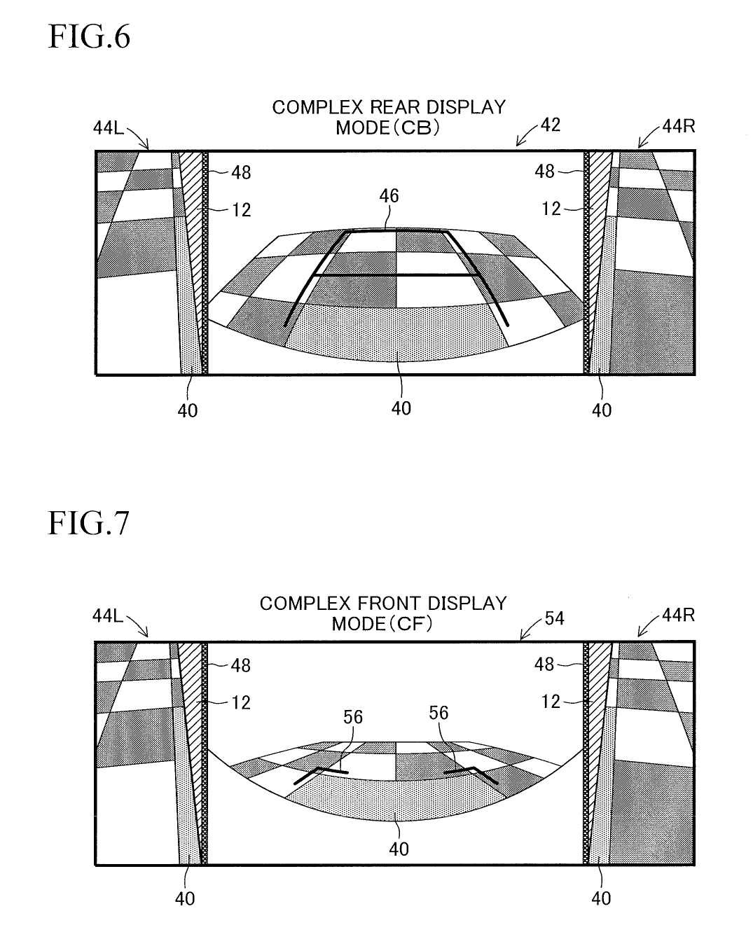

In contrast, in the image illustrated in FIG. 6, the guide lines 46 are not displayed in the left and right obliquely rear images 44L and 44R, and neither the rear-wheel position assist line 50 nor the side assist line 52 is displayed in the images 44L and 44R. Even when the guide lines 46 are not displayed in the left and right obliquely rear images 44L and 44R, at least one of the rear-wheel position assist line 50 and the side assist line 52 may be displayed in the left and right obliquely rear images 44L and 44R.

In any of FIG. 4 to FIG. 6, rear regions displayed in the left and right obliquely rear images 44L and 44R are also displayed in the center image 42. Accordingly, left and right end portions of the guide line 46 and regions surrounding the left and right end portions illustrated in upper portions of FIG. 4 and FIG. 5 are also displayed in the center image 42.

As illustrated in FIG. 3, when the shift position (SP) is switched to “P” (parking position), “D” (drive position), or “N” (neutral position) under a state in which the image display mode is set to the rear display mode (B), that is, to the single rear display mode (SB) or the complex rear display mode (CB), the image display mode is switched to the non-display mode (U).

Further, when the main switch is switched to the front display mode (F) and the shift position (SP) is switched to “D” (drive position) or “N” (neutral position) under the state in which the image display mode is set to the rear display mode (B), the image display mode is switched to the front display mode (F).

<Front Display Mode (F)>

In the front display mode (F), at least a front image of the vehicle 12 taken by the front camera 14 is displayed. In particular, when the image display mode is the single front display mode (SF), only the front image of the vehicle 12 is displayed. In contrast, when the image display mode is the complex front display mode (CF), the front image of the vehicle 12 is displayed, and the obliquely rear images of the vehicle 12 taken by the side cameras 18L and 18R are displayed on left and right sides of the front image, respectively.

FIG. 7 and FIG. 8 are illustrations of examples of images at the time when the image display mode is the complex front display mode (CF). In FIG. 7 and FIG. 8, a center image 54 is the front image of the vehicle 12 taken by the front camera 14, images 44L and 44R on left and right sides of the image 54 are obliquely rear images of the vehicle 12 taken by the side cameras 18L and 18R, respectively. The center image 54 is displayed such that the front side of the vehicle 12 corresponds to the upper side of the image, but the left and right obliquely rear images 44L and 44R are displayed such that the rear side of the vehicle 12 corresponds to the upper side of the image, similarly to the cases of FIG. 4 to FIG. 6. The black lines displayed in the center image 54, which is the image of the travel direction of the vehicle 12, are guide lines 56 for guiding forward travel of the vehicle 12. Between the center image 54 and each of the left and right obliquely rear images 44L and 44R, the separator 48 for separating those images from each other is displayed.

In particular, in the image illustrated in FIG. 7, the guide lines 46 are not displayed in the left and right obliquely rear images 44L and 44R, but in the image illustrated in FIG. 8, the guide lines 46, the rear-wheel position assist lines 50, and the side assist lines 52 are displayed in the left and right obliquely rear images 44L and 44R. The center image 54 is the front image of the vehicle 12, whereas the left and right obliquely rear images 44L and 44R are the obliquely rear images of the vehicle 12. Accordingly, a region displayed in the center image 54 is not displayed in the left and right obliquely rear images 44L and 44R. At least one of the rear-wheel position assist line 50 and the side assist line 52 may be displayed in the image illustrated in FIG. 7, and display of any one of the guide line 46, the rear-wheel position assist line 50, and the side assist line 52 may be omitted in the image illustrated in FIG. 8.

As illustrated in FIG. 3, when the shift position (SP) is switched to “R” (reverse position) under the state in which the image display mode is set to the front display mode (F), that is, to the single front display mode (SF) or the complex front display mode (CF), the image display mode is switched to the rear display mode (B). In this case, when the sub switch is set to the single display mode, the image display mode is switched to the single rear display mode (SB), and when the sub switch is set to the complex display mode, the image display mode is switched to the complex rear display mode (CB).

Further, when the main switches of the touch panel switch 28 and the remote switch 34 are switched to the non-display mode (U) under a state in which the image display mode is set to the front display mode (F), the image display mode is switched to the non-display mode (U).

### Second Embodiment

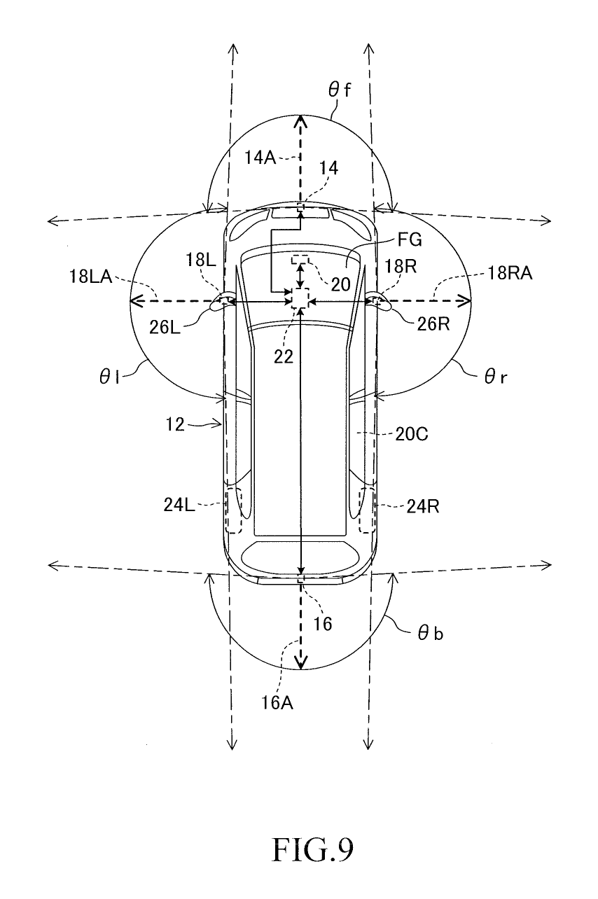

FIG. 9 is a schematic configuration diagram for illustrating the surrounding image display apparatus 10 for a vehicle according to a second embodiment of the present disclosure. In FIG. 9, the same members as those illustrated in FIG. 1 are denoted by the same reference symbols as those of FIG. 1.

The surrounding image display apparatus 10 according to the second embodiment basically has the same configuration as that of the surrounding image display apparatus 10 according to the first embodiment. Therefore, a block diagram of the surrounding image display apparatus 10 according to the second embodiment is not shown. As can be understood from comparison between FIG. 9 and FIG. 1, the front camera 14 and the back camera 16 each function as the travel direction image pickup device in a manner substantially similar to that of the front camera 14 and the back camera 16 according to the first embodiment, respectively. In contrast, the left and right side cameras 18L and 18R function as left and right image pickup devices configured to take left and right side images of the vehicle 12 including left and right obliquely rear regions of the vehicle 12, respectively. The optical axes 18LA and 18RA of the side cameras 18L and 18R are set in left and right side directions of the vehicle 12, respectively.

In the second embodiment, lenses of the back camera 16 and the side cameras 18L and 18R are each a wide-angle lens, e.g., a fisheye lens similarly to the lens of the front camera 14. The cameras 14, 16, 18L, and 18R have angles of view θf, θb, θl, and θr of 180 degrees or more, respectively. Accordingly, the cameras 14, 16, 18L, and 18R can take images all around the vehicle 12 when viewed from above the vehicle 12 in cooperation with one another.

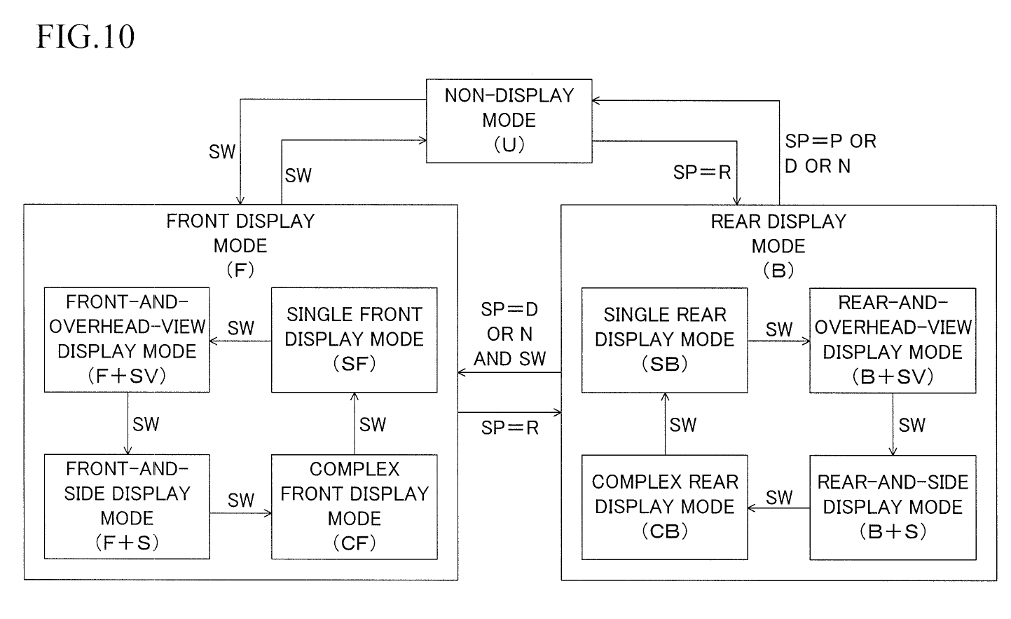

As illustrated in FIG. 10, also in the second embodiment, the image display mode includes the non-display mode (U), the rear display mode (B), and the front display mode (F). The rear display mode includes, in addition to the single rear display mode (SB) and the complex rear display mode (CB), a rear-and-overhead-view display mode (B+SV) and a rear-and-side display mode (B+S). Similarly, the front display mode includes, in addition to the single front display mode (SF) and the complex front display mode (CF), a front-and-overhead-view display mode (F+SV) and a front-and-side display mode (F+S). As described in detail later, the image display mode may be set to be changed through any one of the touch panel switch 28 and the remote switch 34.

Although not shown, also in the second embodiment, the touch panel switch 28 and the remote switch 34 each include the main switch, the sub switch, and the assist line switch. The main switch is configured to switch the image display mode among the non-display mode (U), the rear display mode (B), and the front display mode (F).

The sub switch is configured to switch the image display mode among the single rear display mode (SB), the rear-and-overhead-view display mode (B+SV), the rear-and-side display mode (B+S), and the complex rear display mode (CB) when the image display mode is the rear display mode (B). The sub switch is configured to switch the image display mode among the single front display mode (SF), the front-and-overhead-view display mode (F+SV), the front-and-side display mode (F+S), and the complex front display mode (CF) when the image display mode is the front display mode (F). Similarly to the case of the first embodiment, the assist line switch is configured to switch a mode between a mode of displaying an assist line (described in detail later) in a displayed image and a mode of not displaying the assist line in the displayed image.

The electronic control device 22 functions as a control device configured to control, based on image information input thereto, a set image display mode, and a shift position, an image displayed on the display device 20 in accordance with a control program corresponding to an image switch control diagram of FIG. 10. The electronic control device 22 according to the second embodiment may also be, for example, a microcomputer including a CPU, a ROM, a RAM, and an input/output port, which are connected to one another by a bidirectional common bus.

Next, referring to the image switch control diagram of FIG. 10, an image to be displayed on the display device 20 and image switch control according to the second embodiment are described in detail. In the following description, the camera switch 30 is on. When the camera switch 30 is off, the image display mode is set to the non-display mode (U).

<Non-Display Mode (U)>

When the main switch is in a position of the non-display mode (U), the image display mode is set to the non-display mode (U). In the non-display mode (U), an image taken by the front camera 14 or other cameras is not displayed. Similarly to the case of the first embodiment, when the display device 20 is the display device of the navigation device, an image of the navigation device is displayed. Further, when the display device 20 is the display device other than the display device of the navigation device, no image is displayed.

When the shift position (SP) is switched to “R” under a state in which the image display mode is set to the non-display mode (U), the image display mode is switched to the rear display mode (B). In this case, the image display mode is set to any one of the single rear display mode (SB), the rear-and-overhead-view display mode (B+SV), the rear-and-side display mode (B+S), and the complex rear display mode (CB) depending on setting of the sub switch. Even when the shift position (SP) is switched to a position other than “R”, e.g., “P”, “D”, or “N” under the state in which the image display mode is set to the non-display mode (U), the image display mode is kept at the non-display mode (U).

Further, when the main switch is switched to the front display mode (F) under the state in which the image display mode is set to the non-display mode (U), the image display mode is switched to the front display mode (F). In this case, the image display mode is set to any one of the single front display mode (SF), the front-and-overhead-view display mode (F+SV), the front-and-side display mode (F+S), and the complex front display mode (CF) depending on the setting of the sub switch.

<Rear Display Mode (B)>

In the rear display mode (B), at least an image taken by the back camera 16 is displayed. Through the operation of the sub switch, the image display mode is switched to the single rear display mode (SB), the rear-and-overhead-view display mode (B+SV), the rear-and-side display mode (B+S), and the complex rear display mode (CB) in the stated order.

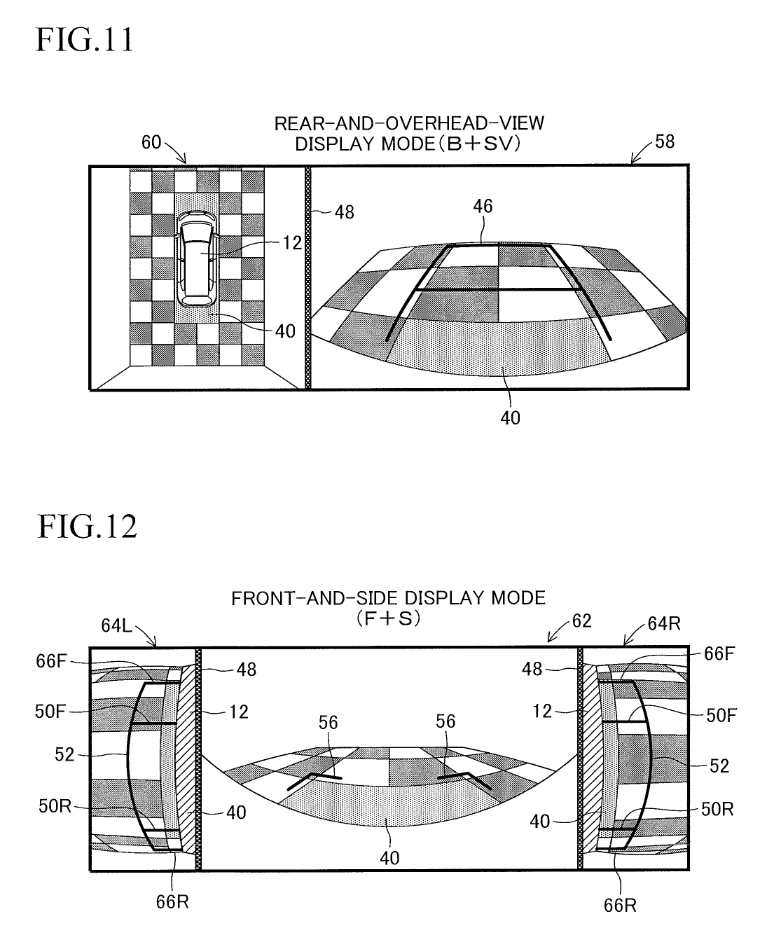

In particular, when the image display mode is the single rear display mode (SB), only the rear image of the vehicle 12 taken by the back camera 16 is displayed. When the image display mode is the rear-and-overhead-view display mode (B+SV), for example, as illustrated in FIG. 11, the rear image of the vehicle 12 and an overhead view image, which is an image of the vehicle 12 and a region surrounding the vehicle 12 viewed from above, are displayed side by side. The overhead view image is generated based on the images taken by the cameras 14, 16, 18L, and 18R, and the overhead view image may be generated by a known method, e.g., a method disclosed in Japanese Patent Application Laid-open No. 2013-21468.

FIG. 11 is an illustration of an example of an image of the rear-and-overhead-view display mode (B+SV). An image 58 in the right part of FIG. 11 is the rear image of the vehicle 12, and the upper side of the image 58 corresponds to the rear side of the vehicle 12. An image 60 in the left part of FIG. 11 is the overhead view image, and the upper side of the image 60 corresponds to the front side of the vehicle 12. Between the rear image and the overhead view image of the vehicle 12, a separator, which is similar to the separator 48, for separating those images from each other is displayed. The guide line 46 is displayed in the rear image.

When the image display mode is the rear-and-side display mode (B+S), although not shown, the rear image of the vehicle 12 taken by the back camera 16 is displayed, and left and right side images of the vehicle 12 (images similar to images 64L and 64R described later) taken by the left and right side cameras 18L and 18R are displayed on left and right sides of the rear image, respectively. Between the rear image of the vehicle 12 and each of the left and right side images, the separator 48 for separating those images from each other is displayed.

Further, when the image display mode is the complex rear display mode (CB), although not shown, the rear image of the vehicle 12 is displayed, and left and right obliquely rear images of the vehicle 12, which are similar to the left and right obliquely rear images according to the first embodiment, are displayed on left and right sides of the rear image, respectively. In this case, the left and right obliquely rear images are generated by subjecting parts of the images taken by the side cameras 18L and 18R that correspond to the rear side of the vehicle 12 to image processing (e.g., trimming and correction of image distortion).

As illustrated in FIG. 10, when the shift position (SP) is switched to “P”, “D”, or “N” under a state in which the image display mode is set to the rear display mode (B), similarly to the first embodiment, the image display mode is switched to the non-display mode (U).

Further, when the main switch is switched to the front display mode (F) and the shift position (SP) is switched to “D” (drive position) or “N” (neutral position) under the state in which the image display mode is set to the rear display mode (B), the image display mode is switched to the front display mode (F). In this case, the image display mode is set to any one of the single front display mode (SF), the front-and-overhead-view display mode (F+SV), the front-and-side display mode (F+S), and the complex front display mode (CF) depending on the setting of the sub switch.

<Front Display Mode (F)>

In the front display mode (F), at least a front image of the vehicle 12 taken by the front camera 14 is displayed. Through an operation of the sub switch, the image display mode is switched to the single front display mode (SF), the front-and-overhead-view display mode (F+SV), the front-and-side display mode (F+S), and the complex front display mode (CF) in the stated order.

In particular, when the image display mode is the single front display mode (SF), only the front image of the vehicle 12 is displayed. When the image display mode is the front-and-overhead-view display mode (F+SV), although not shown, the front image of the vehicle 12 and the overhead view image, which is an image of the vehicle 12 and the region surrounding the vehicle 12 viewed from above, are displayed side by side. Between the front image of the vehicle 12 and the overhead view image, a separator, which is similar to the separator 48, for separating those images from each other is displayed.

When the image display mode is the front-and-side display mode (F+S), the front image of the vehicle 12 is displayed, and the left and right side images of the vehicle 12 taken by the left and right side cameras 18L and 18R are displayed on left and right sides of the front image, respectively. Between the front image of the vehicle 12 and each of the left and right side images, a separator for separating those images from each other is displayed.

FIG. 12 is an illustration of an example of an image of the front-and-side display mode (F+S), and the upper side of FIG. 12 corresponds to the front side of the vehicle 12. A center image 62 of FIG. 12 is the front image of the vehicle 12 taken by the front camera 14, and the guide lines 56 are displayed in the center image 62. Images 64L and 64R on the left and right sides of FIG. 12 are the left and right side images of the vehicle 12 taken by the left and right side cameras 18L and 18R, respectively.

Between the front image 62 of the vehicle 12 and each of the left and right side images 64L and 64R, the separator 48 for separating those images from each other is displayed. In each of the left and right side images 64L and 64R, the side assist line 52, a front-wheel assist line 50F, a rear-wheel assist line 50R, a front-end assist line 66F, and a rear-end assist line 66R are displayed. The front-wheel assist line 50F and the rear-wheel assist line 50R indicate positions where a front wheel and the rear wheel of the vehicle 12 are in contact with the ground, respectively, and the front-end assist line 66F and the rear-end assist line 66R indicate positions of a front end and a rear end of the vehicle 12, respectively.

Further, when the image display mode is the complex front display mode (CF), although not shown, an image taken by the front camera 14 is displayed, and left and right obliquely rear images of the vehicle 12, which are similar to the images taken by the side cameras 18L and 18R according to the first embodiment, are displayed on the left and right sides of the image, respectively. For example, the image displayed in this mode is an image obtained by replacing the images 64L and 64R on the left and right sides of FIG. 12 with the images 44L and 44R on the left and right sides of FIG. 5, respectively.

As illustrated in FIG. 10, when the shift position (SP) is switched to “R” (rear position) under a state in which the image display mode is set to the front display mode (F), the image display mode is switched to the rear display mode (B). In this case, the image display mode is switched to any one of the single rear display mode (SB), the rear-and-overhead-view display mode (B+SV), the rear-and-side display mode (B+S), and the complex rear display mode (CB) depending on the setting of the sub switch.

Further, when the main switch of the touch panel switch 28 or the remote switch 34 is switched to the non-display mode (U) under the state in which the image display mode is set to the front display mode (F), the image display mode is switched to the non-display mode (U).

As can be understood from the above description, according to the above-mentioned first and second embodiments, when the image display mode is the complex rear display mode (CB), the rear image of the vehicle 12 is displayed on the display device 20, and the left and right obliquely rear images of the vehicle 12 are displayed on the left and right sides of the rear image, respectively. Similarly, when the image display mode is the complex front display mode (CF), the front image of the vehicle 12 is displayed on the display device 20, and the left and right obliquely rear images of the vehicle 12 are displayed on the left and right sides of the front image, respectively.

In any of the complex rear display mode (CB) and the complex front display mode (CF), the left and right obliquely rear images are displayed such that the upper side of each image corresponds to the rear side of the vehicle 12, similarly to images reflected in the rear-view mirror and the side-view mirror. Accordingly, a relation between upper and lower sides of the left and right obliquely rear images and front and rear sides of the vehicle 12 is the same as a relation between upper and lower sides of an image reflected in the rear-view mirror and the side-view mirror and the front and rear sides of the vehicle 12. Therefore, when the driver drives the vehicle 12 backward while viewing the images displayed on the display device 20, the driver can check states of left and right obliquely rear sides of the vehicle 12 including the side regions of the left and right rear wheels without being confused. In particular, even when the driver also uses the rear-view mirror or the side-view mirror to check a state of the rear side of the vehicle 12, the probability of the driver being confused can be reduced.

In any of the complex rear display mode (CB) and the complex front display mode (CF), the left and right obliquely rear images of the vehicle 12 are displayed together with the image of the travel direction of the vehicle 12 on the left and right sides of the image. The image of the travel direction of the vehicle 12 is the front image of the vehicle 12 when the travel direction of the vehicle is the forward direction, and is the rear image of the vehicle 12 when the travel direction of the vehicle is the backward direction. Accordingly, by viewing the images displayed on the display device 20, the driver can indirectly view the travel direction of the vehicle 12 and the left and right obliquely rear directions of the vehicle 12. Therefore, even without viewing the images reflected in the rear-view mirror and the side-view mirror, the driver can check the states of the travel direction of the vehicle 12 and the left and right obliquely rear directions of the vehicle 12.

When the vehicle 12 travels backward, the driver can view the rear image of the vehicle 12 to check a state of a rear blind spot of the vehicle 12 that is not reflected in the rear-view mirror, and can view the left and right obliquely rear images of the vehicle 12 to check states of left and right obliquely rear blind spots of the vehicle 12 that are not reflected in the side-view mirrors. Accordingly, in any of a case where the vehicle 12 travels backward straight and a case where the vehicle 12 travels backward while turning, the driver can safely drive the vehicle 12 backward while checking whether or not there is an obstacle or the like in the rear blind spot and left and right obliquely rear blind spots of the vehicle 12. In particular, when the vehicle 12 travels backward while turning, the probabilities of the rear wheel running over an obstacle and of the vehicle 12 colliding with an obstacle can be reduced.

Further, when the vehicle 12 travels forward, the driver can view the front image of the vehicle 12 to check the state of a front blind spot of the vehicle 12, and can view the left and right obliquely rear images of the vehicle 12 to check the states of left and right obliquely rear blind spots of the vehicle 12 that are not reflected in the side-view mirrors. Accordingly, in any of a case where the vehicle 12 travels forward straight and a case where the vehicle 12 travels forward while turning, the driver can safely drive the vehicle 12 forward while checking whether or not there is an obstacle or the like in the front blind spot and left and right obliquely rear blind spots of the vehicle 12. In particular, when the vehicle 12 travels forward while turning, the probabilities of the rear wheel running over an obstacle and of the rear wheel catching on an obstacle can be reduced.

Further, according to the first and second embodiments described above, when the shift position (SP) is switched to “R” (reverse position) under the state in which the image display mode is set to the non-display mode (U) or the front display mode (F), the image display mode is switched to the rear display mode (B). When the image display mode is the rear display mode (B) and the sub switch is set to the complex display mode, the rear image of the vehicle 12 and the left and right obliquely rear images of the vehicle 12 are displayed. Accordingly, unless the travel direction of the vehicle is the backward direction, the rear image of the vehicle 12 and the left and right obliquely rear images of the vehicle 12 are not displayed on the display device 20. Thus, unnecessary display of the rear image and the left and right obliquely rear images of the vehicle 12 can be prevented.

Further, according to the above-mentioned first and second embodiments, the touch panel switch 28 and the remote switch 34 each include the main switch, and the main switch is configured to switch the image display mode among the non-display mode (U), the rear display mode (B), and the front display mode (F). Further, when the main switch is switched to the front display mode (F) under the state in which the image display mode is set to the non-display mode (U) or the rear display mode (B), the image display mode is switched to the front display mode (F).

Accordingly, unless the main switch is switched to the front display mode (F) by the occupant of the vehicle, the front image of the vehicle 12 is not displayed. Thus, unnecessary display of the front image of the vehicle 12 or the front image of the vehicle 12 and the left and right obliquely rear images of the vehicle 12 can be prevented. Further, the occupant of the vehicle can set the image display mode to a mode of displaying the front image of the vehicle 12 by operating the main switch as necessary.

Further, according to the first and second embodiments described above, the guide line 46 for guiding the backward travel of the vehicle 12 is displayed in the rear image of the vehicle 12, and the left and right end portions of the guide line 46 and the regions surrounding the left and right end portions that are displayed in the rear image of the vehicle are also displayed in the left and right obliquely rear images.

Accordingly, the left and right end portions of the guide line 46 and the regions surrounding the left and right end portions are displayed in both of the rear image and the left and right obliquely rear images of the vehicle 12. Therefore, as compared with a case where the left and right end portions of the guide line 46 and the regions surrounding the left and right end portions are displayed in only one of the rear image and the left and right obliquely rear images of the vehicle 12, the driver can more easily and appropriately recognize and grasp a relation between a target object within the rear image of the vehicle 12 and a target object within the left and right obliquely rear images, and a positional relation of the target object with respect to the vehicle 12.

Further, according to the above-mentioned first and second embodiments, the rear-wheel position assist line 50 and the side assist line 52 can be displayed in each of the rear image and the left and right obliquely rear images of the vehicle 12. In the second embodiment, the side assist line 52, the front-wheel assist line 50F, the rear-wheel assist line 50R, the front-end assist line 66F, and the rear-end assist line 66R are displayed in each of the left and right side images. Accordingly, as compared with a case where those assist lines are not displayed, the driver can more easily and appropriately recognize and grasp a positional relation of a surrounding obstacle or the like with respect to the vehicle 12.

Further, according to the above-mentioned first and second embodiments, between the rear image (image 42) and each of the left and right obliquely rear images 44L and 44R of the vehicle 12 and between the front image (image 54) and each of the left and right obliquely rear images 44L and 44R of the vehicle 12, the separator 48 for separating those images from each other is displayed. In the second embodiment, between the rear image 58 and the overhead view image 60 of the vehicle 12 and between the front image 62 and each of the left and right side images 64L and 64R of the vehicle 12, the separator 48 for separating those images from each other is also displayed.

Accordingly, as compared with a case where the separator is not displayed between two or three images that are displayed side by side on the display device 20, the driver can more easily and positively recognize a boundary between those images. Thus, a target object within each image can be recognized more easily.

In particular, according to the first embodiment, the left and right side cameras 18L and 18R are configured to take the left and right obliquely rear images of the vehicle 12 including at least the side regions of the left and right rear wheels 24L and 24R, respectively. In addition, the left and right obliquely rear images 44L and 44R of the vehicle 12 are the images taken by the left and right side cameras 18L and 18R, respectively.

Accordingly, there is no need to generate the left and right obliquely rear images 44L and 44R by processing images taken by the left and right side cameras 18L and 18R respectively configured to take the left and right side images of the vehicle 12. Therefore, as compared with the case of the second embodiment, a load of image processing imposed on the electronic control device 22 can be reduced.

Further, according to the second embodiment, the left and right side cameras 18L and 18R are respectively configured to take the left and right side images of the vehicle 12 and process the images taken by the left and right side cameras 18L and 18R, to thereby generate the left and right obliquely rear images 44L and 44R. Further, in the rear-and-overhead-view display mode (B+SV), the rear image of the vehicle 12 and the overhead view image, which is an image of the vehicle 12 and the region surrounding the vehicle 12 viewed from above, are displayed side by side. In the front-and-side display mode (F+S), the front image of the vehicle 12 and the left and right side images 64L and 64R of the vehicle 12 are displayed.

Accordingly, the number of types of images displayed in the second embodiment is larger than that of the first embodiment, and hence according to the second embodiment, the driver can more accurately check a state surrounding the vehicle.

The specific embodiments of the present disclosure are described in detail above. However, the present disclosure is not limited to the embodiments described above. It is apparent to those skilled in the art that various other embodiments may be employed within the scope of the present disclosure.

For example, according to the above-mentioned first and second embodiments, when the image display mode is the complex display mode, the rear or front image of the vehicle 12 is displayed, and the left and right obliquely rear images are displayed on left and right sides of the rear or front image, respectively. However, only one of the left and right obliquely rear images may be displayed together with the rear or front image of the vehicle 12.

Further, according to the above-mentioned first and second embodiments, when the main switch is switched to the front display mode (F) and the shift position (SP) is switched to “D” or “N” under the state in which the image display mode is set to the rear display mode (B), the image display mode is switched to the front display mode (F). However, the first or second embodiment may be modified such that when the main switch is switched to the front display mode (F), the image display mode is switched to the front display mode (F) irrespective of the shift position (SP).

Further, according to the above-mentioned first embodiment, the left and right side cameras 18L and 18R are respectively configured to take the left and right obliquely rear images of the vehicle, and when the image display mode is the complex display mode, the left and right obliquely rear images are displayed together with the rear or front image of the vehicle 12. However, similarly to the case of the second embodiment, the left and right side cameras 18L and 18R may be configured to take the left and right side images of the vehicle 12, and the left and right obliquely rear images may be generated by subjecting the parts of the images taken by the side cameras 18L and 18R that correspond to the rear side of the vehicle 12 to image processing.

Further, according to the above-mentioned second embodiment, when the image display mode is the rear-and-side display mode (B+S), the rear image of the vehicle 12 is displayed, and the left and right side images of the vehicle 12 are displayed on the left and right sides of the rear image, respectively. Similarly, when the image display mode is the front-and-side display mode (F+S), the front image of the vehicle 12 is displayed, and the left and right side images of the vehicle 12 are displayed on the left and right sides of the front image, respectively. However, the side image of the vehicle 12 may be displayed on one side of the rear or front image of the vehicle 12, and the obliquely rear image of the vehicle 12 may be displayed on the other side. In particular, when the vehicle 12 travels backward while turning, it is preferred that the side image of the vehicle 12 be displayed on an outer side of the turn and the obliquely rear image of the vehicle 12 be displayed on an inner side of the turn.

Further, according to each of the above-mentioned embodiments, the side cameras 18L and 18R are mounted to the left and right side-view mirrors 26L and 26R of the vehicle 12, respectively. However, the side cameras may be mounted to vehicle body parts other than the side-view mirrors, e.g., center pillars.

Further, according to each of the above-mentioned embodiments, when the camera switch 30 is off, the image display mode is set to the non-display mode (U). However, each of the embodiments may be modified such that, even when the camera switch 30 is off, the rear image of the vehicle 12 is displayed when the shift position (SP) is “R” (reverse position).

Further, the guide lines 42 and 56, the side assist line 52, the front-wheel assist line 50F, the rear-wheel assist line 50R, the front-end assist line 66F, and the rear-end assist line 66R described in each of the above-mentioned embodiments are exemplary, and the guide lines and the assist lines are not limited to the modes and types illustrated in the drawings. In other words, the modes and types of the guide lines and the assist lines may be set appropriately depending on a vehicle to which the surrounding image display apparatus 10 according to the present disclosure is applied.

What is claimed is:

1. A surrounding image display apparatus for a vehicle, comprising:
a left image pickup device configured to take a left obliquely rear image of the vehicle including at least a side region of a left rear wheel;
a right image pickup device configured to take a right obliquely rear image of the vehicle including at least a side region of a right rear wheel;
a display device arranged in a vehicle cabin; and
a control device configured to control an image displayed on the display device,
wherein when a preset condition is satisfied, the control device displays on the display device at least one of the left obliquely rear image and the right obliquely rear image, which are taken by the left image pickup device and the right image pickup device, respectively, such that a rear side of the vehicle corresponds to an upper side of the at least one of the left obliquely rear image and the right obliquely rear image.

2. A surrounding image display apparatus for a vehicle according to claim 1, further comprising a travel direction image pickup device configured to take an image of a travel direction of the vehicle,
wherein when the preset condition is satisfied, the control device displays on the display device the image of the travel direction of the vehicle taken by the travel direction image pickup device, and the left obliquely rear image and the right obliquely rear image on left and right sides of the image of the travel direction of the vehicle, respectively.

3. A surrounding image display apparatus for a vehicle according to claim 2,
wherein the travel direction image pickup device comprises a rear image pickup device configured to take a rear image of the vehicle, and
wherein when the preset condition is satisfied, the control device displays on the display device the rear image of the vehicle taken by the rear image pickup device, and the left obliquely rear image and the right obliquely rear image on left and right sides of the rear image of the vehicle, respectively.

4. A surrounding image display apparatus for a vehicle according to claim 3, wherein the preset condition comprises a condition that the travel direction of the vehicle is a backward direction.

5. A surrounding image display apparatus for a vehicle according to claim 4, wherein the control device is configured to display a guide line for guiding backward travel of the vehicle in the rear image of the vehicle, and to display left and right end portions of the guide line and regions surrounding the left and right end portions that are displayed in the rear image of the vehicle also in the left obliquely rear image and the right obliquely rear image, respectively.

6. A surrounding image display apparatus for a vehicle according to claim 2,
wherein the travel direction image pickup device comprises a front image pickup device configured to take a front image of the vehicle, and
wherein when the preset condition is satisfied, the control device displays on the display device the front image of the vehicle taken by the front image pickup device, and the left obliquely rear image and the right obliquely rear image on left and right sides of the front image of the vehicle, respectively.

7. A surrounding image display apparatus for a vehicle according to claim 6, further comprising a switch to be operated by an occupant of the vehicle to set an image display mode,
wherein the preset condition comprises a condition that the image display mode set through the switch is a mode of displaying the front image of the vehicle.

8. A surrounding image display apparatus for a vehicle according to claim 2, wherein the control device is configured to display, between the image of the travel direction of the vehicle and each of the left obliquely rear image and the right obliquely rear image, a separator for separating the images from each other.
